(19) United States
(12) Patent Application Publication
(10) Pub. No.: US 2024/0154274 A1
(43) Pub. Date: May 9, 2024

(54) POWER STORAGE CELL, AND METHOD OF SHORT-CIRCUITING BETWEEN LID AND EXTERNAL TERMINAL

(71) Applicant: TOYOTA JIDOSHA KABUSHIKI KAISHA, Toyota-shi (JP)

(72) Inventors: Satomi YAMAMOTO, Miyoshi-shi (JP); Masayoshi Haga, Nagoya-shi (JP); Masashi Chihara, Nagoya-shi (JP); Takenori Ikeda, Owariasahi-shi (JP); Nana Kurashita, Toyota-shi (JP)

(73) Assignee: TOYOTA JIDOSHA KABUSHIKI KAISHA, 1, Toyota-shi (JP)

(21) Appl. No.: 18/471,889

(22) Filed: Sep. 21, 2023

(30) Foreign Application Priority Data
Nov. 7, 2022 (JP) 2022-177975

(51) Int. Cl. H01M 50/578; H01M 50/15; H01M 50/176

(52) U.S. Cl. CPC H01M 50/578; H01M 50/15; H01M 50/176; H01M 2200/20

(57) ABSTRACT

A power storage cell comprises an electrode assembly, a cell case, and an external terminal. The cell case has a case body and a lid. The lid has a lid body electrically charged with the same polarity as that of a positive electrode or a negative electrode, an invertible plate capable of short-circuiting between the lid body and the external terminal, and a prevention part connected to the invertible plate. The invertible plate is deformable between a normal shape and an inverted shape. The lid body has a receiving portion that receives the prevention part when the invertible plate is in the inverted shape. The receiving portion allows the prevention part to pass therethrough when the invertible plate is deforming from the normal shape to the inverted shape, and is in contact with the prevention part when the invertible plate is in the inverted shape.

### CROSS REFERENCE TO RELATED APPLICATIONS

This nonprovisional application is based on Japanese Patent Application No. 2022-177975 filed on Nov. 7, 2022, with the Japan Patent Office, the entire contents of which are hereby incorporated by reference.

### BACKGROUND

### Field

The present disclosure relates to a power storage cell, and to a method of short-circuiting between a lid and an external terminal.

### Description of the Background Art

Japanese Patent Laying-Open No. 2015-204284 discloses a rechargeable battery comprising an electrode assembly, a case accommodating the electrode assembly, and a cap assembly connected to the case. The case is open upward. The cap assembly has a cap plate secured to the opening of the case, a pair of terminal plates connected to the upper surface of the cap plate, and an inversion plate connected to the cap plate. The cap plate is electrically connected to the terminal plate of the positive electrode, and the inversion plate is electrically connected to the cap plate. Above the inversion plate, the terminal plate of the negative electrode is located.

In this power storage cell, when the inversion plate is inverted, the inversion plate comes into contact with the terminal plate of the negative electrode. Due to this, a short circuit occurs between the terminal plate of the positive electrode and the terminal plate of the negative electrode via the inversion plate and the cap plate, which causes a short-circuit current to flow in the inversion plate.

### SUMMARY

In the rechargeable battery described in Japanese Patent Laying-Open No. 2015-204284, due to vibration and the like, the inversion plate may be inverted again (re-inverted) in the direction away from the terminal plate.

An object of the present disclosure is to provide a power storage cell, as well as a method of short-circuiting between a lid and an external terminal, both of which make it possible to prevent re-inversion of the invertible plate.

A power storage cell according to an aspect of the present disclosure comprises an electrode assembly, a cell case accommodating the electrode assembly, and an external terminal secured to an upper surface of the cell case, wherein the cell case has a case body accommodating the electrode assembly and having an opening that is open upward and a lid connected to the case body so as to close the opening of the case body, the lid has a lid body connected to the opening of the case body and electrically charged with the same polarity as that of a positive electrode or a negative electrode in the electrode assembly, an invertible plate connected to the lid body and capable of short-circuiting between the lid body and the external terminal, and a prevention part connected to the invertible plate, the invertible plate is deformable between a normal shape that curves to protrude in a direction away from the external terminal and an inverted shape that curves to protrude toward the external terminal and is in contact with the external terminal, the lid body has a receiving portion that receives the prevention part when the invertible plate is in the inverted shape, and the receiving portion allows the prevention part to pass therethrough when the invertible plate is deforming from the normal shape to the inverted shape, and is in contact with the prevention part when the invertible plate is in the inverted shape to prevent deformation of the invertible plate from the inverted shape toward the normal shape.

A method of short-circuiting between a lid and an external terminal according to an aspect of the present disclosure is a method of short-circuiting between a lid and an external terminal of a power storage cell, wherein the power storage cell comprises an electrode assembly, a cell case accommodating the electrode assembly, and an external terminal secured to an upper surface of the cell case, the cell case has a case body accommodating the electrode assembly and having an opening that is open upward and a lid connected to the case body so as to close the opening of the case body, the lid has a lid body connected to the opening of the case body and electrically charged with the same polarity as that of a positive electrode or a negative electrode in the electrode assembly, an invertible plate connected to the lid body and capable of short-circuiting between the lid body and the external terminal, and a prevention part connected to the invertible plate, and the lid body has a receiving portion that receives the prevention part; and the method comprises, when an internal pressure of the cell case reaches a certain pressure or higher, inverting the invertible plate and allowing the prevention part to pass through the receiving portion, and, in a state in which the invertible plate is in contact with the external terminal, keeping the prevention part in contact with the receiving portion to maintain the state of contact between the invertible plate and the external terminal.

The foregoing and other objects, features, aspects and advantages of the present disclosure, when taken in conjunction with the accompanying drawings will become more apparent from the following detailed description of the present disclosure.

### BRIEF DESCRIPTION OF THE DRAWINGS

FIG. 1 is a perspective view schematically illustrating a power storage cell according to First Embodiment of the present disclosure.

FIG. 2 is an exploded perspective view of the power storage cell illustrated in FIG. 1.

FIG. 3 is a cross-sectional view of the power storage cell illustrated in FIG. 1.

FIG. 4 is an enlarged cross-sectional view of an invertible plate and its surroundings.

FIG. 5 is a cross-sectional view schematically illustrating the state of an invertible plate after its movement.

FIG. 6 is an enlarged cross-sectional view of an invertible plate according to a modification and its surroundings.

FIG. 7 is a cross-sectional view schematically illustrating the state of the invertible plate illustrated in FIG. 6 after its movement.

FIG. 8 is an enlarged cross-sectional view of an invertible plate according to a modification and its surroundings.

FIG. 9 is a cross-sectional view schematically illustrating the state of the invertible plate illustrated in FIG. 8 after its movement.

FIG. 10 is an enlarged cross-sectional view of an invertible plate according to a modification and its surroundings.

FIG. 11 is a cross-sectional view schematically illustrating the state of the invertible plate illustrated in FIG. 10 after its movement.

FIG. 12 is an enlarged cross-sectional view of an invertible plate according to a modification and its surroundings.

FIG. 13 is a cross-sectional view schematically illustrating the state of the invertible plate illustrated in FIG. 12 after its movement.

FIG. 14 is a perspective view schematically illustrating a power storage cell according to Second Embodiment of the present disclosure.

FIG. 15 is an exploded perspective view of the power storage cell illustrated in FIG. 14.

### DESCRIPTION OF THE PREFERRED EMBODIMENTS

A description will be given of embodiments of the present disclosure, with reference to drawings. In the drawings referenced below, the same or equivalent members are denoted by the same numeral.

### First Embodiment

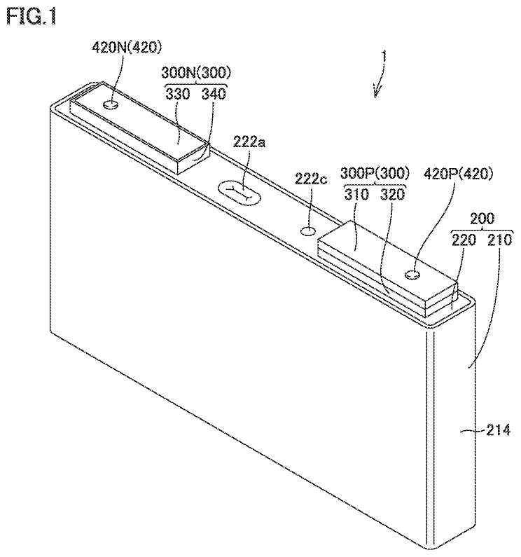

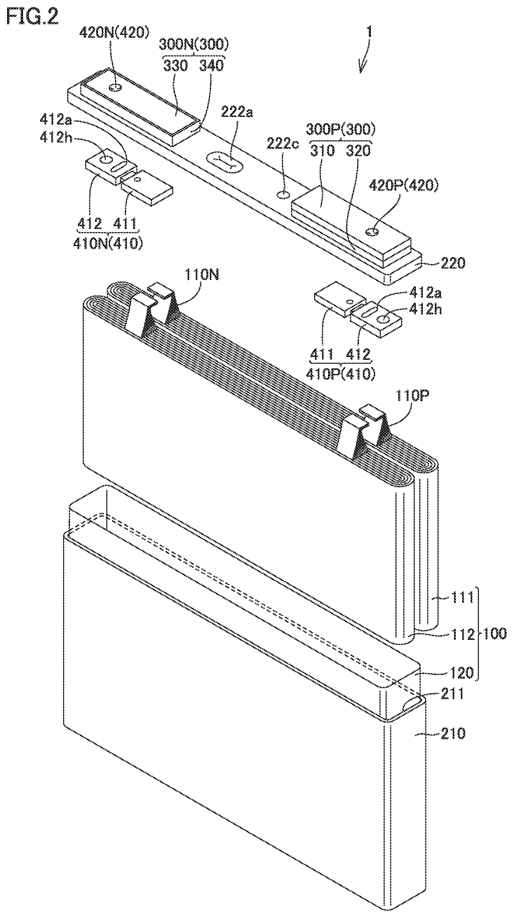

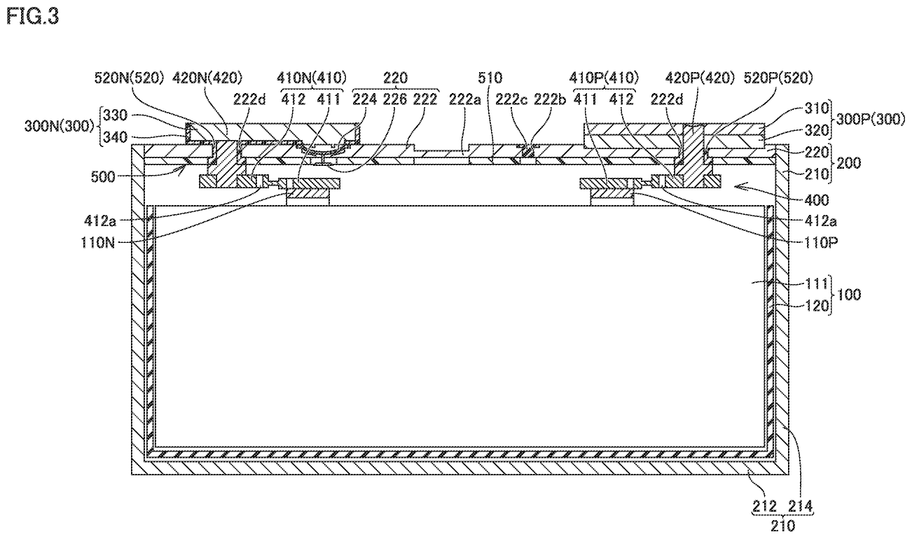

FIG. 1 is a perspective view schematically illustrating a power storage cell according to First Embodiment of the present disclosure. FIG. 2 is an exploded perspective view of the power storage cell illustrated in FIG. 1. FIG. 3 is a cross-sectional view of the power storage cell illustrated in FIG. 1.

As illustrated in FIG. 1 to FIG. 3, a power storage cell 1 comprises an electrode assembly 100, a cell case 200, an external terminal 300, a connecting member 400, and an insulating member 500.

Electrode assembly 100 has a plurality of unit electrode assemblies 111, 112 and an insulating film 120. In the present embodiment, the plurality of unit electrode assemblies comprise two unit electrode assemblies 111, 112. Each unit electrode assembly 111, 112 includes a plurality of tabs, namely, a plurality of positive electrode tabs 110P and a plurality of negative electrode tabs 110N. Unit electrode assemblies 111, 112 have the same structure. Hence, in the following, unit electrode assembly 111 will be described.

Unit electrode assembly 111 includes a positive electrode sheet, a separator, and a negative electrode sheet. Each of the positive electrode sheet, the negative electrode sheet, and the separator is formed in a long rectangular shape.

The positive electrode sheet includes a metal foil and a positive electrode composite material layer formed on the metal foil. The upper long side of the metal foil is provided with an uncoated portion to which the positive electrode composite material layer is not provided, and at this uncoated portion, the plurality of positive electrode tabs 110P are formed with some space between them.

The negative electrode sheet includes a metal foil and a negative electrode composite material layer formed on the metal foil. The upper long side of the metal foil is provided with an uncoated portion to which the negative electrode composite material layer is not provided, and at this uncoated portion, the plurality of negative electrode tabs 110N are formed with some space between them.

In a state where the sheets are wound in a roll, positive electrode tabs 110P are aligned in the thickness direction (the direction in FIG. 3 orthogonal to the surface of the paper), and negative electrode tabs 110N are aligned in the thickness direction. Positive electrode tab 110P and negative electrode tab 110N are spaced from each other in the width direction (the direction orthogonal to both the thickness direction and the height direction).

Insulating film 120 has a shape covering both the circumferential surface and the bottom surface of a set of the plurality of unit electrode assemblies 111, 112.

Cell case 200 accommodates electrode assembly 100. Cell case 200 also accommodates an electrolyte solution, which is not illustrated in the drawings. Cell case 200 is hermetically sealed. Cell case 200 has a case body 210 and a lid 220.

Case body 210 has an opening 211 that is open upward. Case body 210 is made of a metal such as aluminum. Case body 210 has a bottom wall 212 and a circumferential wall 214. Bottom wall 212 is formed in a rectangular flat shape. Circumferential wall 214 rises upward from bottom wall 212. Circumferential wall 214 is formed in a rectangular tubular shape. The length of circumferential wall 214 in the width direction is longer than the length of circumferential wall 214 in the thickness direction. The length of circumferential wall 214 in the height direction is longer than the length of circumferential wall 214 in the thickness direction.

Lid 220 closes opening 211 of case body 210. Lid 220 is connected to opening 211 by welding and/or the like. Lid 220 is formed in a flat shape. Lid 220 is made of a metal such as aluminum. Lid 220 has a lid body 222, an invertible plate 224, and a prevention part 226.

Lid body 222 is connected to case body 210 by welding and/or the like. Lid body 222 is provided with a pressure relief valve 222a, a liquid inlet hole 222b, a sealing member 222c, and a pair of pin-inserting holes 222d.

Pressure relief valve 222a is formed at the central portion of lid body 222. Pressure relief valve 222a is formed to break when the internal pressure of cell case 200 reaches a certain pressure or higher. When pressure relief valve 222a breaks, gas inside cell case 200 is released through pressure relief valve 222a to the outside of cell case 200, and thereby the internal pressure of cell case 200 decreases.

Liquid inlet hole 222b is a through hole through which the electrolyte solution is injected into cell case 200 during production of power storage cell 1.

Sealing member 222c is a member that seals liquid inlet hole 222b. Liquid inlet hole 222b is sealed by sealing member 222c after the electrolyte solution is injected into case body 210.

The pair of pin-inserting holes 222d are formed with some space between them in the width direction. Each pin-inserting hole 222d is a through hole through which a connecting pin 420 described below is inserted.

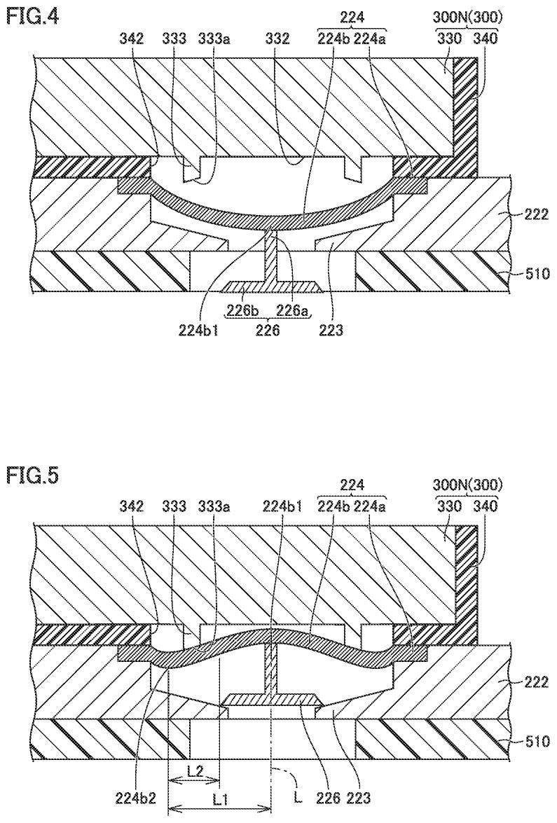

Invertible plate 224 is connected to lid body 222 by welding and/or the like. Invertible plate 224 is capable of short-circuiting between lid body 222 and external terminal 300. As illustrated in FIG. 4, invertible plate 224 has a base portion 224a and an invertible portion 224b.

Base portion 224a is connected to lid body 222 by welding and/or the like. In the present embodiment, base portion 224a is connected to a portion of lid body 222 located below a negative electrode terminal plate 330 described below. Base portion 224a is formed in a ring shape, and, more specifically, in a circular ring shape.

Invertible portion 224b is connected to the inner side of base portion 224a. Invertible portion 224b is formed in a disk shape. Invertible portion 224b is deformable between a normal shape that curves to protrude in a direction away from negative electrode terminal plate 330 (the shape illustrated in FIG. 4) and an inverted shape that curves to protrude toward negative electrode terminal plate 330 and is in contact with negative electrode terminal plate 330 (the shape illustrated in FIG. 5). While the internal pressure of cell case 200 is less than a certain pressure (namely, under normal circumstances), invertible portion 224b is in the normal shape as illustrated in FIG. 4. When the internal pressure of cell case 200 reaches the certain pressure or higher, invertible portion 224b deforms from the normal shape to the inverted shape as illustrated in FIG. 5. By this, invertible portion 224b comes into contact with negative electrode terminal plate 330.

Prevention part 226 is connected to invertible plate 224. More specifically, prevention part 226 is connected to the lower surface of invertible portion 224b. Prevention part 226 is made of an elastically deformable material. Prevention part 226 prevents deformation of invertible portion 224b from the inverted shape to the normal shape. Prevention part 226 has a secured portion 226a and a foot portion 226b.

Secured portion 226a is a portion that is secured to the lower surface of invertible portion 224b. Secured portion 226a is secured to a top portion 224b1 of invertible portion 224b. In the present embodiment, secured portion 226a has a shape that extends in a direction away from invertible portion 224b.

Foot portion 226b extends from secured portion 226a. Foot portion 226b may have a plurality of foot portion elements that have a shape extending radially from secured portion 226a toward the outside of invertible portion 224b. The plurality of foot portion elements are spaced from each other in the circumferential direction of invertible portion 224b. Foot portion 226b may be formed in a circular ring shape.

As illustrated in FIG. 4 and FIG. 5, lid body 222 has a receiving portion 223 that receives prevention part 226 when invertible plate 224 is in the inverted shape. Receiving portion 223 is provided to lid body 222 at a position overlapping invertible plate 224 in the height direction. Receiving portion 223 allows prevention part 226 to pass therethrough when invertible plate 224 is deforming from the normal shape to the inverted shape. On the other hand, when invertible plate 224 is in the inverted shape, receiving portion 223 stays in contact with prevention part 226 to prevent deformation of invertible plate 224 from the inverted shape toward the normal shape.

The outer edge of foot portion 226b faces receiving portion 223. As illustrated in FIG. 4 and FIG. 5, the distance between the outer edges of foot portion 226b in the width direction is larger than the distance between the edges of receiving portion 223 in the same direction. It should be noted that at the time when invertible portion 224b deforms from the normal shape to the inverted shape, foot portion 226b deforms elastically to pass through receiving portion 223. After invertible portion 224b is inverted and foot portion 226b passes through receiving portion 223, foot portion 226b is in contact with receiving portion 223.

External terminal 300 is secured to the upper surface of cell case 200. To external terminal 300, a bus bar (which is not illustrated in the drawings) is connected by welding and/or the like. External terminal 300 has a positive electrode member 300P and a negative electrode member 300N.

Positive electrode member 300P is connected to the upper surface of cell case 200 by welding and/or the like. Positive electrode member 300P has a positive electrode terminal plate 310 and a terminal block 320.

Positive electrode terminal plate 310 is formed in the shape of a rectangular parallelepiped. Positive electrode terminal plate 310 is made of a metal such as aluminum.

Terminal block 320 is formed in the shape of a rectangular parallelepiped. Terminal block 320 is made of a metal (such as iron) that is different from the metal forming the positive electrode terminal plate 310. Terminal block 320 is connected to the upper surface of lid body 222 by welding, and to the upper surface of terminal block 320, positive electrode terminal plate 310 is connected by welding and/or the like. In other words, case body 210 and lid 220 are electrically connected to positive electrode terminal plate 310 with terminal block 320 being present therebetween, and are electrically charged with the same polarity as that of positive electrode terminal plate 310. Each of positive electrode terminal plate 310 and terminal block 320 is provided with a through hole through which a positive electrode connecting pin 420P described below is inserted.

Negative electrode member 300N is connected to the upper surface of cell case 200 by welding and/or the like. Negative electrode member 300N is spaced from positive electrode member 300P in the width direction. Negative electrode member 300N has a negative electrode terminal plate 330 and an insulating plate 340.

Negative electrode terminal plate 330 is formed in the shape of a substantial rectangular parallelepiped. Negative electrode terminal plate 330 is placed above invertible plate 224. As illustrated in FIG. 4, negative electrode terminal plate 330 has a facing portion 332 facing invertible plate 224. Facing portion 332 is formed flat.

In the present embodiment, negative electrode terminal plate 330 has a protruding portion 333 protruding from facing portion 332 toward invertible plate 224. Protruding portion 333 may be formed in a circular ring shape, or may have a pair of protruding elements located at positions flanking the central axis L (see FIG. 5) of invertible portion 224b in the width direction. As illustrated in FIG. 4 and FIG. 5, protruding portion 333 has a contact surface 333a which has a shape that follows the contour of invertible plate 224 in the inverted shape. As described above, when the internal pressure of cell case 200 is less than a certain pressure (namely, under normal circumstances), invertible portion 224b of invertible plate 224 is spaced from contact surface 333a, and when the internal pressure of cell case 200 reaches the certain pressure or higher, invertible portion 224b is in contact with contact surface 333a.

As illustrated in FIG. 5, invertible portion 224b in the inverted shape is provided with a curved portion 224b2 that curves to protrude downward. Contact surface 333a is preferably formed at a position that is in contact with a region of the upper surface of invertible portion 224b between curved portion 224b2 and a location which is a second length L2 inward/away from curved portion 224b2 in a direction parallel to the width direction. Second length L2 is half the distance, L1, between curved portion 224b2 and the central axis L of invertible portion 224b in a direction parallel to the width direction.

Insulating plate 340 is secured to the upper surface of lid 220. Insulating plate 340 supports negative electrode terminal plate 330. Insulating plate 340 insulates lid 220 from negative electrode terminal plate 330. Each of negative electrode terminal plate 330 and insulating plate 340 is provided with a through hole through which a negative electrode connecting pin 420N described below is inserted. As illustrated in FIG. 3 and FIG. 4, insulating plate 340 has an exposure hole 342 through which facing portion 332 is exposed.

Connecting member 400 connects the plurality of tabs 110P, 110N and external terminal 300. Connecting member 400 has a current collector plate 410 and connecting pin 420.

Current collector plate 410 is connected to the plurality of tabs. Current collector plate 410 has a positive electrode current collector plate 410P and a negative electrode current collector plate 410N.

Positive electrode current collector plate 410P is connected to the plurality of positive electrode tabs 110P by welding and/or the like. Positive electrode current collector plate 410P has a first flat-plate portion 411 and a second flat-plate portion 412.

To first flat-plate portion 411, the plurality of positive electrode tabs 110P are connected by ultrasonic welding and/or the like. First flat-plate portion 411 is provided with a through hole. The plurality of positive electrode tabs 110P are connected to the lower surface of first flat-plate portion 411. Alternatively, the plurality of positive electrode tabs 110P may be connected to the upper surface of first flat-plate portion 411.

Second flat-plate portion 412 is placed on the outside of first flat-plate portion 411 in the width direction. Second flat-plate portion 412 is provided with a connecting hole 412h and a fuse portion 412a. Fuse portion 412a is constituted of a through hole that penetrates through second flat-plate portion 412 in the thickness direction thereof. As illustrated in FIG. 3, a thin portion may be formed between second flat-plate portion 412 and first flat-plate portion 411.

Negative electrode current collector plate 410N is connected to the plurality of negative electrode tabs 110N by welding and/or the like. The configuration of negative electrode current collector plate 410N is substantially the same as the configuration of positive electrode current collector plate 410P.

Connecting pin 420 connects current collector plate 410 and external terminal 300. Connecting pin 420 has positive electrode connecting pin 420P and negative electrode connecting pin 420N.

Positive electrode connecting pin 420P connects positive electrode current collector plate 410P and positive electrode terminal plate 310. Positive electrode connecting pin 420P is formed in a cylindrical shape. The lower end of positive electrode connecting pin 420P, in a state where it is inserted inside of connecting hole 412h, is connected to second flat-plate portion 412. The upper end of positive electrode connecting pin 420P is swaged to positive electrode terminal plate 310.

Negative electrode connecting pin 420N connects negative electrode current collector plate 410N and negative electrode terminal plate 330. Negative electrode connecting pin 420N is formed in a cylindrical shape. The lower end of negative electrode connecting pin 420N, in a state where it is inserted inside of connecting hole 412h, is connected to second flat-plate portion 412. The upper end of negative electrode connecting pin 420N is swaged to negative electrode terminal plate 330.

Insulating member 500 insulates connecting member 400 from cell case 200. Insulating member 500 has an insulating sheet 510 and an insulator 520.

Insulating sheet 510 is connected to the lower surface of lid body 222. Insulating sheet 510 is provided with through holes at a portion overlapping pressure relief valve 222a, a portion overlapping liquid inlet hole 222b, a portion overlapping each pin-inserting hole 222d, and a portion overlapping invertible plate 224 (in each case, the portion in question overlaps in the height direction).

Insulator 520 has a shape surrounding connecting pin 420, and insulates connecting pin 420 from cell case 200. Insulator 520 has a positive-electrode-side insulator 520P and a negative-electrode-side insulator 520N.

Positive-electrode-side insulator 520P covers positive electrode connecting pin 420P. Positive-electrode-side insulator 520P is formed in a round tubular shape. Positive-electrode-side insulator 520P insulates positive electrode connecting pin 420P from lid body 222.

Negative-electrode-side insulator 520N covers negative electrode connecting pin 420N. The structure of negative-electrode-side insulator 520N is the same as the structure of positive-electrode-side insulator 520P.

In power storage cell 1 as describe above, when the internal pressure of cell case 200 rises to reach the above-mentioned certain pressure or higher due to an occurrence of an abnormality of electrode assembly 100, invertible portion 224b of invertible plate 224 is inverted as illustrated in FIG. 5 (namely, it deforms from the normal shape to the inverted shape) and thereby comes into contact with contact surface 333a of negative electrode terminal plate 330. By this, external terminal 300, connecting member 400, and electrode assembly 100 together form a closed circuit with lid 220 being present therebetween, causing a flow of a high electric current in the circuit. Then, fuse portion 412a provided to second flat-plate portion 412 fuses. As a result, electric connection between electrode assembly 100 and cell case 200 is interrupted.

When invertible plate 224 is inverted (namely, when it deforms from the normal shape to the inverted shape), prevention part 226 comes into contact with receiving portion 223 as illustrated in FIG. 5 and, thereby, deformation of invertible plate 224 from the inverted shape to the normal shape, namely re-inversion of invertible plate 224, is prevented.

In the following, modifications in the above-described embodiment will be described.

(First Modification)

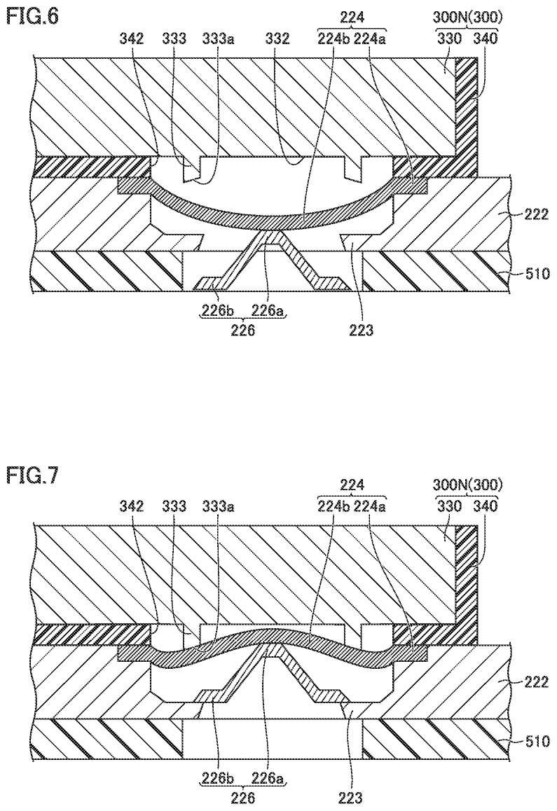

As illustrated in FIG. 6 and FIG. 7, foot portion 226b of prevention part 226 has a shape that is inclined in such a manner that it goes progressively outward in the width direction as it goes down from secured portion 226a.

(Second Modification)

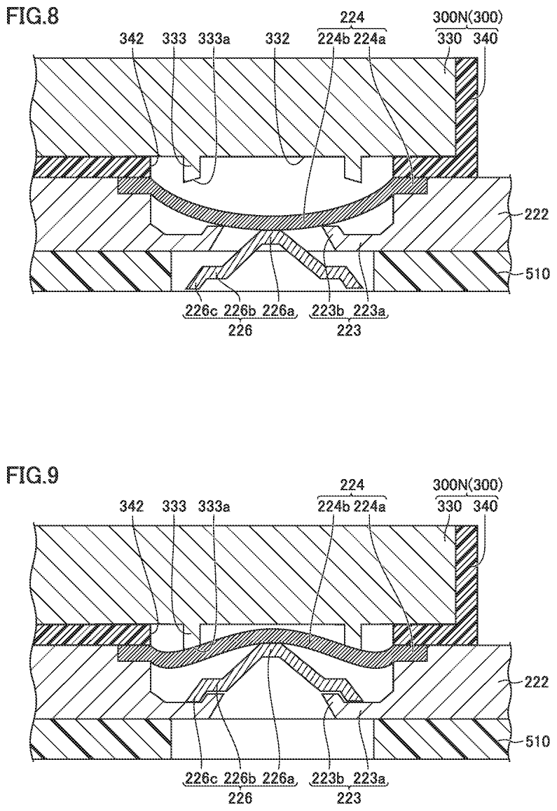

As illustrated in FIG. 8 and FIG. 9, prevention part 226 further has a protrusion 226c protruding downward from the outer edge of foot portion 226b. Receiving portion 223 has a base 223a facing protrusion 226c, as well as a rising wall 223b rising from the inner end of base 223a and facing foot portion 226b. This modification is also applicable to prevention part 226 in the above-described embodiment.

(Third Modification)

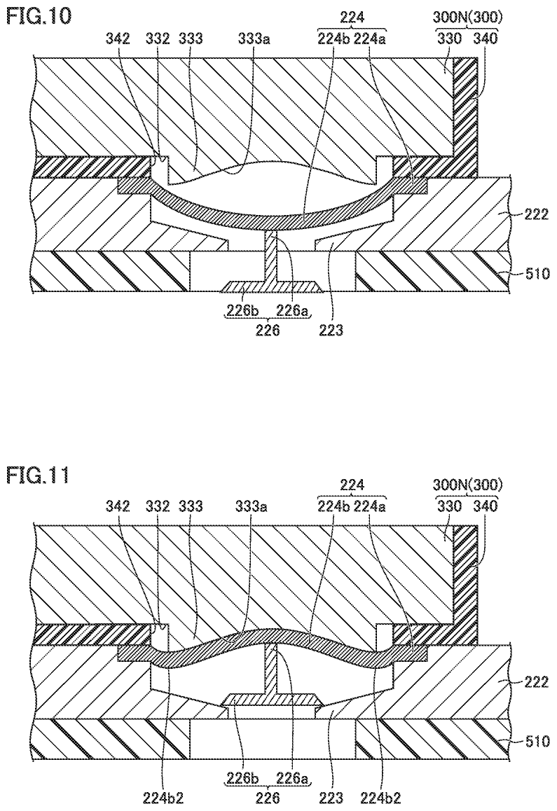

As illustrated in FIG. 10 and FIG. 11, contact surface 333a of protruding portion 333 has a shape that comes into contact with the entire area of the upper surface of invertible portion 224b in the inverted shape positioned inward from curved portion 224b2.

(Fourth Modification)

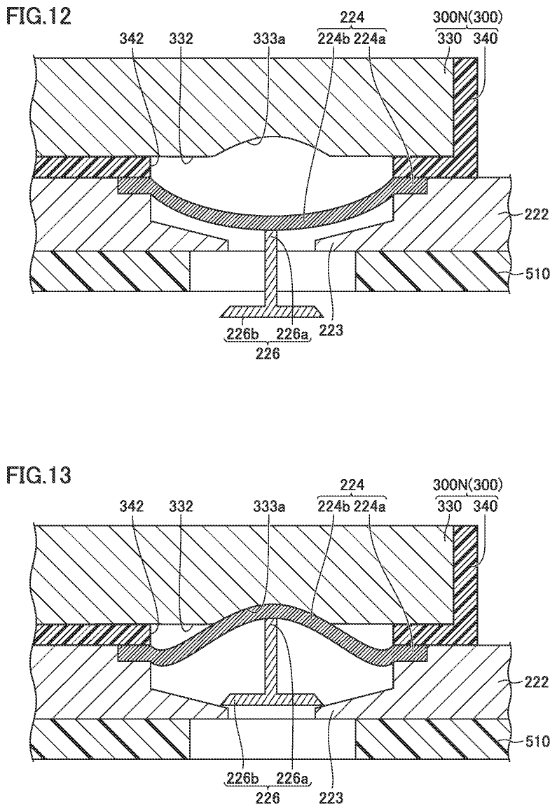

As illustrated in FIG. 12 and FIG. 13, negative electrode terminal plate 330 does not have protruding portion 333, and facing portion 332 is provided with contact surface 333a.

### Second Embodiment

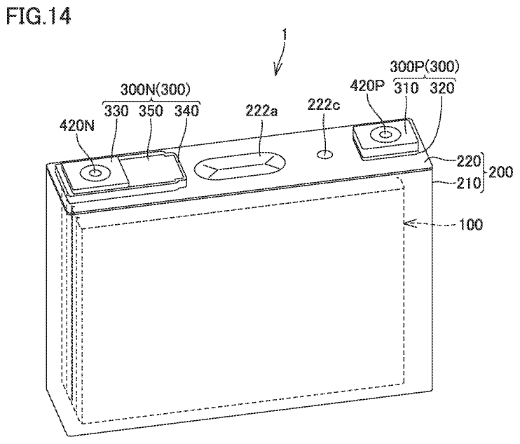

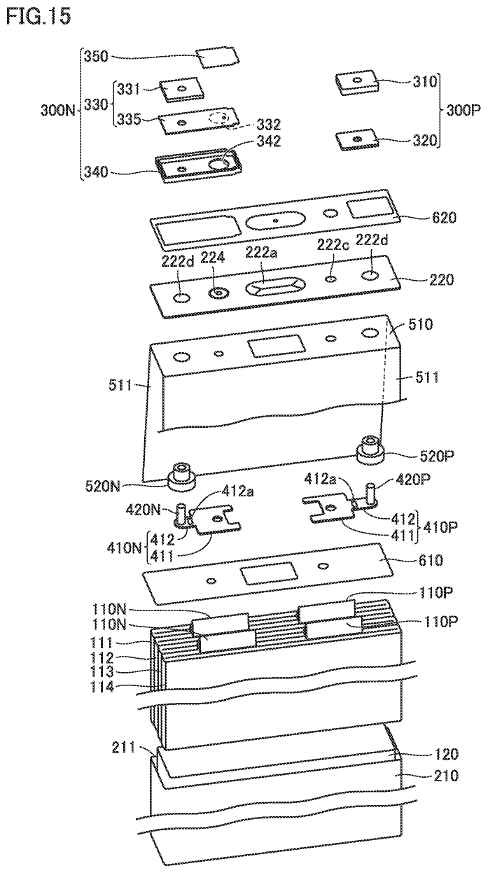

Next, referring to FIG. 14 and FIG. 15, power storage cell 1 according to Second Embodiment of the present disclosure will be described. The below description of Second Embodiment only explains about the parts that are different from First Embodiment, and explanation of the same structure, action, and effect as in First Embodiment will not be repeated.

Power storage cell 1 according to the present embodiment further comprises an inner insulator 610 and an outer insulator 620.

Inner insulator 610 is placed inside cell case 200. More specifically, inner insulator 610 is interposed between electrode assembly 100 and current collector plate 410. Each of positive electrode tab 110P and negative electrode tab 110N is connected to current collector plate 410 at a position above inner insulator 610. Inner insulator 610 is provided with a through hole, at a portion that overlaps the through hole of first flat-plate portion 411 in the height direction. In the present embodiment, as illustrated in FIG. 15, electrode assembly 100 has four unit electrode assemblies 111 to 114.

Outer insulator 620 is placed on the outside of cell case 200. More specifically, outer insulator 620 is placed on the upper surface of lid 220. Outer insulator 620 is provided with through holes, at a portion overlapping positive electrode member 300P, a portion overlapping negative electrode member 300N, a portion overlapping pressure relief valve 222a, and a portion overlapping liquid inlet hole 222b (in each case, the portion in question overlaps in the height direction).

As illustrated in FIG. 15, insulating member 500 further has a pair of side sheets 511 connected to insulating sheet 510. Each side sheet 511 has a shape that extends downward from a thickness-direction edge of insulating sheet 510. Each side sheet 511 is interposed between a side of electrode assembly 100 and case body 210.

As illustrated in FIG. 14 and FIG. 15, negative electrode member 300N further has an insulating panel 350. Moreover, negative electrode terminal plate 330 has a terminal block 331 and an electrically-conductive plate 335. Electrically-conductive plate 335 is secured on insulating plate 340, and, to electrically-conductive plate 335, terminal block 331 is connected by welding and/or the like. Each of electrically-conductive plate 335 and terminal block 331 is provided with a through hole through which negative electrode connecting pin 420N is inserted. Electrically-conductive plate 335 has facing portion 332. Insulating panel 350 covers a portion of electrically-conductive plate 335 that is located above invertible plate 224.

A person skilled in the art will appreciate that the above-described example embodiments are specific examples of the following aspects.

[Aspect 1]

A power storage cell comprising:
an electrode assembly;
a cell case accommodating the electrode assembly; and
an external terminal secured to an upper surface of the cell case, wherein
the cell case has:
   a case body accommodating the electrode assembly and having an opening that is open upward; and
   a lid connected to the case body so as to close the opening of the case body,
the lid has:
   a lid body connected to the opening of the case body and electrically charged with the same polarity as that of a positive electrode or a negative electrode in the electrode assembly;
   an invertible plate connected to the lid body and capable of short-circuiting between the lid body and the external terminal; and
   a prevention part connected to the invertible plate,
the invertible plate is deformable between a normal shape that curves to protrude in a direction away from the external terminal and an inverted shape that curves to protrude toward the external terminal and is in contact with the external terminal,
the lid body has a receiving portion that receives the prevention part when the invertible plate is in the inverted shape, and
the receiving portion allows the prevention part to pass therethrough when the invertible plate is deforming from the normal shape to the inverted shape, and is in contact with the prevention part when the invertible plate is in the inverted shape to prevent deformation of the invertible plate from the inverted shape toward the normal shape.

In this power storage cell, when the invertible plate is inverted (namely, when it deforms from the normal shape to the inverted shape), the prevention part comes into contact with the receiving portion, and, thereby, deformation of the invertible plate from the inverted shape to the normal shape, namely re-inversion of the invertible plate, is prevented.

[Aspect 2]

The power storage cell according to Aspect 1, wherein
the prevention part has:
   a secured portion secured to a lower surface of the invertible plate;
   a foot portion extending from the secured portion and facing the receiving portion; and
   a protrusion protruding downward from an outer edge of the foot portion, and
the receiving portion has:
   a base facing the protrusion; and
   a rising wall rising from an inner end of the base and facing the foot portion.

In this aspect, the protrusion and the rising wall engage with each other, and, thereby, deformation of the invertible plate from the inverted shape to the normal shape is prevented more reliably.

[Aspect 3]

The power storage cell according to Aspect 1 or 2, wherein the external terminal has a contact surface having a shape that follows an contour of the invertible plate in the inverted shape.

In this aspect, the area of contact between the invertible plate and the external terminal is ensured, and, thereby, contact resistance between the invertible plate and the external terminal is reduced. As a result, heat produced by the invertible plate while a current is passing through the invertible plate is reduced.

[Aspect 4]

A method of short-circuiting between a lid and an external terminal of a power storage cell, wherein the power storage cell comprises an electrode assembly, a cell case accommodating the electrode assembly, and an external terminal secured to an upper surface of the cell case, the cell case has a case body accommodating the electrode assembly and having an opening that is open upward and a lid connected to the case body so as to close the opening of the case body, the lid has a lid body connected to the opening of the case body and electrically charged with the same polarity as that of a positive electrode or a negative electrode in the electrode assembly, an invertible plate connected to the lid body and capable of short-circuiting between the lid body and the external terminal, and a prevention part connected to the invertible plate, and the lid body has a receiving portion that receives the prevention part, and the method comprising, when an internal pressure of the cell case reaches a certain pressure or higher, inverting the invertible plate and allowing the prevention part to pass through the receiving portion, and, in a state in which the invertible plate is in contact with the external terminal, keeping the prevention part in contact with the receiving portion to maintain the state of contact between the invertible plate and the external terminal.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A power storage cell comprising:
an electrode assembly;
a cell case accommodating the electrode assembly; and
an external terminal secured to an upper surface of the cell case, wherein
the cell case has:
a case body; and
a lid connected to the case body,
the lid has:
a lid body connected to the case body and electrically charged with the same polarity as that of a positive electrode or a negative electrode in the electrode assembly;
an invertible plate connected to the lid body and capable of short-circuiting between the lid body and the external terminal; and
a prevention part connected to the invertible plate,
the invertible plate is deformable between a normal shape spaced from the external terminal and an inverted shape in contact with the external terminal,
the lid body has a receiving portion that receives the prevention part when the invertible plate is in the inverted shape, and
the receiving portion allows the prevention part to pass therethrough when the invertible plate is deforming to the inverted shape, and is in contact with the prevention part when the invertible plate is in the inverted shape.

2. The power storage cell according to claim 1, wherein
the prevention part has:
a secured portion secured to a lower surface of the invertible plate;
a foot portion extending from the secured portion and facing the receiving portion; and
a protrusion protruding downward from an outer edge of the foot portion, and
the receiving portion has:
a base facing the protrusion; and
a rising wall rising from an inner end of the base and facing the foot portion.

3. The power storage cell according to claim 1, wherein the external terminal has a contact surface having a shape that follows an contour of the invertible plate in the inverted shape.

4. A method of short-circuiting between a lid and an external terminal in a power storage cell, the power storage cell comprising an electrode assembly, a cell case accommodating the electrode assembly, and an external terminal secured to an upper surface of the cell case, the cell case having a case body and a lid connected to the case body, the lid having a lid body connected to the case body and electrically charged with the same polarity as that of a positive electrode or a negative electrode in the electrode assembly, an invertible plate connected to the lid body and capable of short-circuiting between the lid body and the external terminal, and a prevention part connected to the invertible plate, the lid body having a receiving portion that receives the prevention part, the method comprising:
when an internal pressure of the cell case reaches a certain pressure or higher, inverting the invertible plate and allowing the prevention part to pass through the receiving portion, and, in a state in which the invertible plate is in contact with the external terminal, keeping the prevention part in contact with the receiving portion to maintain the state of contact between the invertible plate and the external terminal.
